(19) United States
(12) Patent Application Publication
(10) Pub. No.: US 2019/0309815 A1
(43) Pub. Date: Oct. 10, 2019

(54) LEAF SPRING DEVICE FOR A VEHICLE, CHASSIS WITH SUCH A LEAF SPRING DEVICE AND A METHOD FOR PRODUCING SUCH A LEAF SPRING DEVICE AND/OR SUCH A CHASSIS

(71) Applicant: ZF Friedrichshafen AG, Friedrichshafen (DE)

(72) Inventors: Marcel PLEYER, Melle (DE); Thomas RUPFLIN, Stetten (DE); Sami Uddin SIDDIQUI, Lemfoerde (DE); Clemens HACKER, Osnabrueck (DE)

(21) Appl. No.: 16/374,971

(22) Filed: Apr. 4, 2019

(30) Foreign Application Priority Data
Apr. 6, 2018 (DE) 10 2018 205 215.8

(51) Int. Cl. F16F 1/368; F16F 1/20; F16F 1/18; B60G 11/10

(52) U.S. Cl. CPC F16F 1/368; F16F 1/20; B60G 2204/121; B60G 11/10; F16F 1/185

(57) ABSTRACT

A leaf spring device (1, 101) for a vehicle with a spring leaf (2, 102) made from a fiber-enforced plastic. In order to realize the stiffness and/or a progressive suspension of the leaf spring device (1, 101) during increasing spring stress, the spring leaf is has an inner space (5, 6, 105, 106), which is at least partially or completely filled with an elastic material.

This application claims priority from German patent application serial no. 10 2018 205 215.8 filed Apr. 6, 2018.

### FIELD OF THE INVENTION

The invention concerns a leaf spring device for a vehicle with a spring leaf manufactured from a fiber-reinforced plastic. In addition, the invention concerns a chassis with such a leaf spring device, as well as a method for the manufacturing of such a leaf spring device and/or such a chassis.

### BACKGROUND OF THE INVENTION

Such a leaf spring device is known through DE 10 2010 015 951 A1. Hereby, a progressive run for a force-distance curve is created if a leaf spring device is used which is assembled with several spring leafs, which are each suitably designed and connected to each other or, respectively, are positioned in a spring leaf group.

In addition, the leaf spring devices are known made of metal, in which several spring leafs are used, made of metal and different lengths and/or quantity. Hereby, at least one of the spring leaf functions first at a certain or predetermined, respectively, path whereby the stiffness of the leaf spring device is increased. Such a leaf spring device and/or progressive suspension, with an increased stiffness, is required, for instance, for the loads with certain weight classes or with high load capacity. Hereby, a nearly steady construction-resonant frequency can be guaranteed which increases the driving safety.

In the case of a multi-leaf leaf spring device with at least one spring leaf made from fiber-reinforced plastic, however, there is a risk in particular with a multi-leaf design that unwanted damage will occur in the area of contact of the spring leaf made from fiber-enforced plastic with another spring leaf. In particular, the penetration of dirt particles and/or abrasion in the area of a contact surface of the spring leaf made from fiber-enforce plastic can create an unwanted damage of the leaf spring device, which means that the operational safety is in danger and/or the operational life of the leaf spring device might be reduced. Thus, an increased stiffness and/or a progressive suspension for a multi-leaf leaf spring device with at least one spring leaf made from a fiber plastic compound, in particular glass fiber plastic, cannot readily be realized.

### SUMMARY OF THE INVENTION

It is a basic object of the invention to further design a leaf spring device, a chassis, and/or a method of the above mentioned art in such a way that, the use of a leaf spring device with a spring leaf made from fiber-enforced plastic, the stiffness of a leaf spring device increases at higher spring load and/or a progressive suspension can be realized. In particular, an alternative embodiment is expected to be created.

The basic task for the invention is solved with a leaf spring device, a chassis, and/or a method according to the independent claim(s). Preferred additional embodiments of the invention can be found in the dependent claims and the following description.

The leaf spring device is designed for use in a vehicle and/or motor vehicle. In particular, the spring leaf device is positioned in a chassis of a vehicle and/or motor vehicle. Hereby, the leaf spring device can be connected to an axle, a rigid axle, a wheel axle, a wheel carrier, and/or transversal control arm. The axle can be designed as rear axle or as a front axle. Hereby, the leaf spring device can be positioned in a longitudinal direction or a transverse direction. The leaf spring device has at least one or a single spring leaf. The spring leaf is created from a fiber-enforced plastic and/or a plastic fiber compound. In the inventive spring leaf device an inner space is provided. The inner space is at least partially or completely filled with an elastic material. Alternatively, the inner space is not filled at all. In this case, the inner space has therefore no partial or complete filling.

The advantage hereby is that, due to the provision of the inner space which is in particular partially or completely filled with an elastic material, the characteristics of the leaf spring device are changeable depending on the spring track and/or a spring load. In particular, the stiffness of the leaf spring device can be increased at increasing spring load and/or a progressive suspension can be realized. The inner space can be designed as open or closed. The inner space can be designed or marked as an accommodation space for the elastic material.

The leaf spring device can have a holding device to connect the leaf spring device and/or the spring leaf with an axle. The holding device can create a bearing for the spring leaf. In particular and due to the bearing and/or by means of the holding device, deformation of the spring leaf is enabled. Thus and due to the holding device and/or the bearing, the spring leaf, in particular at least a leaf spring section can be deformed. In particular the spring leaf section is a partial section of the spring leaf. The leaf spring section can be positioned between two ends of the spring leaf. Preferably, the spring leaf sections within the ends of the spring leaf are distanced from each other. In particular, the spring leaf sections are positioned in the area of the inner space. The spring leaf sections can be partially or completely surrounding the inner space. Preferably, the inner space is positioned in the spring leaf section and/or the inner space is created due to the spring leaf section. Preferably, a deformation needs to be understood as bending. The deformation can be designed to being elastic. In particular, the deformation or bending of the spring leaf is pointed in a direction which is transverse or perpendicular to the longitudinal extension of the spring leaf and/or a longitudinal axle of the axle. Preferably the spring leaf, in particular in a no-load condition of the leaf spring device, has a curved or bent shape.

A no-load condition of the leaf spring device can refer to an uninstalled condition of the leaf spring device with respect to the assembly in a chassis and/or vehicle. Alternatively, the no-load condition of the leaf spring device in a vehicle and/or chassis can be referenced as an installed condition of the leaf spring device wherein a spring load has an effect at the spring leaf which corresponds to the maximum of the spring load in an empty condition or in a no load condition of the vehicle.

In accordance with another embodiment, the elastic material is positioned between the inner side of the inner space and a spring leaf section of the spring. In particular, the elastic material touches on one side the inner side of the inner space and on the other side an inner side or an outer perimeter of the spring leaf section. Hereby, the elastic material can be firmly connected with the inner side of the inner space and/or firmly connected with the inner side or the outer perimeter of the spring leaf section. Preferably, the elastic material is an elastomer material. The elastomer material can be an elastic, deformable plastic and/or an elastic deformable plastic material or rubber material. Thus, as the elastic material, an elastic plastic material or an elastic rubber material can be used. In particular, the elastic material is compressibly designed, for instance as a foam elastomer. Preferably the elastic material is not compressible or cannot be compressed, respectively. The elastic material and or the elastomeric material can be elastically deformed under tensile and/or compressive load. In particular the elastic material can return to its original form after a force was applied.

Due to the inner space, and/or an interaction of the elastic material with the spring leaf section of the spring leaf which is associated with the inner space, an increased suspension and or a progressive suspension can be realized due to the stiffness of the leaf spring device. In particular, a stiffness of the leaf spring device creates an increased suspension and/or a progressive suspension during an increased spring load with the increased bending of the spring leaf. In particular, with a progressive suspension and/or progressive spring-characteristic curve, a stiffness of the leaf spring device is increased beginning with a predetermined spring load and/or with an increased spring load. Preferably and by means of a progressive suspension, a higher or increasing, respectively, spring rate can be realized for a vehicle during an increasing load condition. The stiffness can be, in particular at the beginning with the predetermined spring load, continuously or exponentially be increased or enlarged. Alternatively, the stiffness and in particular at the beginning of the predetermined spring load, can increase or change in a certain, limited, or predetermined spring section or spring load section. In an additional, predetermined spring load, a certain stiffness can be accomplished and which remains constant during a further increasing spring load. Hereby, the stiffness can be increased with an increasing spring load in accordance with an asymptotic function up to a determined or the maximum stiffness.

Preferably, the inner space and/or the elastic material create, in particular up to a predetermined spring load and/or up to a predetermined acting spring force, an at least partially decoupling of the spring leaf section from the spring leaf. Up to reaching and the predetermined spring load and/or acting spring force, a bending load cannot or only partially of the spring leaf section, in particular through the elastic material, interact with the additional parts of the spring leaf. Only just at the predetermined spring load and/or acting spring load, the spring leaf section can be loaded or bending together with additional parts of the spring leaf. In particular in the elastic material cannot be further deformed at the predetermined spring load and/or acting spring load, but can at a decreasing spring load and/or acting spring load only return from the maximal, deformed condition in the direction of its original shape.

Until the predetermined spring load and/or acting spring load is reached, the spring leaf section, in particular preferably, can be loaded for stretching. The spring leaf section can be, in particular elastically deformed. A deformation shall be understood as torsion and or bending. At the reaching a predetermined spring load, the spring leaf section can mainly be loaded for a stretching, while the spring leaf section starting at the predetermined spring load and with an increasing spring load, is mainly loaded for bending. Hereby, the stretching load of the spring leaf section can be remain mostly constant at the predetermined spring load and with increasing spring load, but also further increased or reduced.

In particular, the spring leaf, the spring leaf section, and the elastic material are designed to realize a stiffness of the leaf spring device for an increased suspension and/or a progressive suspension whereby, beginning at a no-load condition of the leaf spring device, the elastic material is increasingly compressed and or compacted when the spring load increases. Next hereby or at the same time, the spring leaf section can increasingly be loaded whereby the leaf spring device gets stiffer with an increasing spring load. In particular, the spring leaf section is only just loaded at a predetermined spring load, in particular mainly and bending. Beginning at the predetermined spring load and with an increasing spring load, the spring leaf section, in particular in addition to an already happened deformation, can mainly be loaded or bending. Thus, the stiffness of the leaf spring device can be increased with an increasing spring load. A progressive suspension and/or progressive spring characteristic curve can hereby be realized.

In accordance with a further embodiment, the inner space is designed as a cavity in the spring leaf. The inner space can be completely positioned inside of the spring leaf. In particular, the inner space is partially or completely filled with the elastic material. A spring leaf section of the spring leaf can be partially or completely surrounded by the elastic material. In particular, the spring leaf section can be completely surrounded by the elastic material or enclosed by it. Hereby, the spring leaf section can be reliably protected from the environmental influence.

Preferably, the inner space is designed as a through hole. The passage opening can extend from a first side of the spring leaf to a second side of the spring leaf which is facing away from the first side. In particular, the inner space in a vehicle and/or in a chassis installed condition of the leaf spring device extends transverse or perpendicular to a vertical vehicle axis. The passage opening can be partially or completely filled by means of the elastic material and/or the spring leaf section.

In particular, the inner space is positioned between the pressure side and a tension side of the spring leaf. Hereby the spring leaf section itself can be the tension side or represent the tension side. The spring leaf section can be positioned between the pressure side and the tension side of the spring leaf. In particular the spring leaf section is positioned between the tension side and the inner space.

Preferably, the spring leaf is mirror symmetrical to a median plane. Hereby, the median plane can extend perpendicular to a longitudinal axis and/or longitudinal extension of the leaf spring device and/or a vehicle longitudinal axis. In particular, the median plane in the installed condition of the leaf spring device in a chassis and/or in a vehicle is vertically positioned. Alternatively, the leaf spring device and/or the spring leaf can be asymmetrically designed, in particular to a median plane with two ends of the spring leaf at equal distances. The leaf spring device can be mounted by means of two, opposite to each other, mounting devices at the ends as a bearing for the leaf spring device. In addition, the leaf spring device with a median plane, particularly centered between the two mounting devices, can be connected with the axle. Hereby the leaf spring device can possess a holding device. The axle can be designed as a wheel axle and/or a rigid axle. In particular, the axle extends in an installed condition in a vehicle and/or a chassis in a direction which is transverse or perpendicular to the vehicle's longitudinal axis.

Preferably, the spring leaf has an inner space. Thus, the inner space can be designed as an integral part of the spring leaf. Preferably, the spring leaf is together with the inner space designed as one piece. In particular, the inner space is not just created through a simple piling of two separate or self-contained, respectively, spring leafs. Preferably, the leaf spring device and/or the spring leaf has a first inner space with the elastic material and a second inner space with the elastic material, in particular, the two inner spaces are distanced from each other and/or spatially separated from each other. The two inner spaces can be positioned on a common longitudinal axis of the spring leaf. The first inner space and the second inner space can be designed as mirror-symmetrical to each other and/or to a median plane of the spring leaf.

According to a separate possible embodiment and independent from the present embodiment, a spring leaf section of the spring leaf can be loaded, mainly for stretching, up to reaching a predetermined spring load. Preferably, the spring leaf section can be loaded mainly for bending, beginning at a predetermined spring load or when reaching a predetermined spring load, respectively. Hereby, the load for bending can take place in addition to the already reached stretching load. The stretching load of the spring leaf section starting at the predetermined spring load and with a further increasing spring load can mainly remain constant, also increase or decrease.

In particular, alternate or equivalent terms for “mainly” need to be understood as: predominantly, essentially, principally. Preferably, in a predominant stretch, the proportion of stretch in a deformation of the spring leaf is greater than 50%, greater than 75% or greater than 90%. For a predominant bend, the amount of bend in the deformation may be greater than 50%, greater than 75%, or greater than 90%.

Thus, a leaf spring device can be realized in which, in a first operation mode, the spring leaf section is mainly loaded for stretching and, in an additional operation mode, the spring leaf section in particular in addition to the already reached stretching load, is mainly loaded for bending.

In accordance with a further embodiment, a spring leaf section of the spring leaf is, in a no-load condition of the leaf spring device, convexly arched, in particular to the outside. In particular, the spring leaf section in a no-load, uninstalled, or in a no-load, installed condition of the leaf spring device in a vehicle, is convexly arched in the direction of the vehicle's vertical axis to the outside and/or upward. Hereby, the spring leaf section can be designed as a part of a tension side of the spring leaf.

In accordance with an additional embodiment, one side or a tension side of the spring leaf, in particular in a no-load condition of the leaf spring device, is designed wavelike. Hereby, a spring leaf section of the spring leaf can be designed as a wave crest, wherein the spring leaf section and/or the wave crest is positioned in the area of the interior. In particular, the interior is realized as a wave crest due to the formation of the spring leaf section.

According to an embodiment that is also conceivable independently of the present application, a spring leaf section of the spring leaf extends like a sword into the interior space, the spring leaf section of the spring leaf extends sword-shaped into the inner space. Hereby, the elastic material can on one side touch an inner perimeter of the inner space and touch on the other side an outer perimeter of the sword-shaped spring leaf section. In particular the elastic material is firmly connected with the inner perimeter of the inner space in firmly connected with the outer perimeter of the sword-shaped spring leaf section. Beginning at a no-load condition of the spring leaf device, the elastic material is, with an increasing spring load, increasingly compressed and therefore the sword-shaped spring leaf section is increasingly loaded. In particular, the elastic material which surrounds the sword-shaped spring leaf section will be increasingly deformed and/or compressed. Hereupon or at the same time, the sword-shaped spring leaf section is loaded, whereby the leaf spring device with the increasing spring load becomes increasingly stiffer.

In an additional embodiment, the sword-shaped spring leaf section extends, in particular starting from a median plane of the spring leaf, in the longitudinal direction of the spring leaf and/or in the direction of one and of the spring leaf. Preferably, the sword-shaped spring leaf section is designed as one piece with the median section and/or spring leaf. In particular, a first, sword-shaped spring leaf section extends, starting from the median section in the direction of a first end of the spring leaf and a second spring leaf section, starting from the median section in the direction and of a second end of the spring leaf which is facing in an opposite direction to the first end of the spring leaf. Herein, the first sword-shaped spring leaf section can be positioned in a first inner space and the second sword-shaped spring leaf section in a second inner space of the spring leaf.

Preferably, the leaf spring device is designed as single leaf. In a single leaf design of the leaf spring device a single spring leaf provided. It is conceivable as an alternative that the leaf spring device is designed as multi-leaf type, in particular as dual-leaf type. In a dual-leaf embodiment of the leaf spring device, it has a first spring leaf and a second spring leaf. In particular, the first spring leaf and the second spring leaf are connected with each other to create at least one inner space between the first spring leaf and the second spring leaf. Herein, the first spring leaf and the second spring leaf can be distanced from each other to create the inner space in the area of the inner space. The connection of the first spring leaf with the second spring leaf can be designed as firmly bonded.

In particular, the spring leaf is manufactured from a fiber plastic compound and/or a glass fiber plastic compound. The spring leaf can be built with several fiber layers. In particular, the fiber layers are impregnated by means of a matrix material and/or connected with each other. The application of fiber-reinforced plastic in building the spring leaf allows a weight reduction, in particular in comparison with a leaf spring device with a metal spring leaf. In particular, the spring leaf is designed as a longitudinal leaf spring or a transverse leaf spring. In the design as a longitudinal leaf spring, the leaf spring device and/or the spring leaf can extend in an installed condition in the longitudinal direction of the vehicle or motor vehicle, respectively.

Of a special advantage is a chassis with the invented spring leaf device for a vehicle or a motor vehicle. Herein, the spring leaf, in particular by means of a holding device, can be connected with an axle. The stiffness of the leaf spring device can be lower in a first operating mode than in an additional operating mode. Preferably, in the first operating mode primarily happens in particular an increasing compression of the elastic material in the inner space. In the additional operating mode, due to the compressed elastic material, an increasing bending can take place of the spring leaf section with the increasing spring load. In particular, the leaf spring device is below a predetermined spring load in the first operating mode and beginning at the predetermined spring load in the additional operating mode.

In addition, a method for the production, in accordance with the invention, of a leaf spring device and/or a chassis, in accordance with the invention, presents an advantage. Hereby, a spring leaf is manufactured from a fiber-reinforced plastic. An inner space is created in which an elastic material is positioned and/or inserted. In particular, the spring leaf is manufactured in a way so that the spring leaf creates and/or as the inner space. At first, the spring leaf can be produced with the inner space and thereafter, the elastic material can be inserted into the inner space. Hereby, the elastic material can be positioned between the spring leaf and a spring leaf section of the spring leaf, whereby the spring leaf section is, beginning at a predetermined spring load, increasingly or mainly loaded for bending. In particular, beginning at the predetermined spring load and with an increasing spring load, the spring leaf section is loaded, especially in addition to an already occurred deformation, mainly for bending.

In particular, the spring leaf and the elastic material are manufactured like layers and/or a lamination. Preferably, the leaf spring device is built up and/or layer-like and/or produced in a layered manner. Thus, the leaf spring device itself or as a whole, respectively, can be created as layers and/or manufactured. Hereby, a first and/or lowest partial section of the spring leaf can be established and/or manufactured. Thereafter, the elastic material is on the first and/or lowest partial section of the leaf spring positioned, or established, and/or manufactured. Then, an additional and/or top partial section of the spring leaf can be brought on top of the elastic material, positioned, and/or manufactured. In parallel or simultaneously during the establishing or manufacturing, respectively of the elastic material section, the end sections and/or the median section of the spring leaf can be established and/or manufactured. By means of these and sections, a first end and a second end of the spring leaf can be created. The median section can be positioned between two elastic material sections. After establishing the leaf spring device, a fiber-enforced plastic of the leaf spring can be consolidated and/or hardened through a suitable method. Hereby, it might be for instance a RTM method (RTM: Resin Transfer Molding).

In particular, a continuous, in particular sheet-like or layered, structure of the leaf spring device is made possible. In accordance with an additional alternative, the spring leaf and the elastic material can be manufactured simultaneously or in parallel, in particular independent from each other.

In particular, this inventive method for the manufacturing of a leaf spring device presents, in accordance with the invention, the previously described inventive leaf spring device. Preferably, the method is further develop in accordance with all of the here presented embodiments in connection with the invention of the leaf spring device. Also, the here described leaf spring device can be further enhanced in accordance with all the described embodiments in connection with the method.

### BRIEF DESCRIPTION OF THE DRAWINGS

Hereinafter, the invention is further described based on the drawings. Hereby, same reference characters refer to the same, similar, or functionally the same parts or elements. It shows:

FIG. 1 a sectional side view of first leaf spring device according to the invention,

FIG. 2 a section of the sectional side view of the first leaf spring device of FIG. 1 according to the invention,

FIG. 3 a sectional side view of another leaf spring device according to the invention, and

FIG. 4 a section of the sectional side view of the additional leaf spring device as in FIG. 3.

### DETAILED DESCRIPTION OF THE PREFERRED EMBODIMENTS

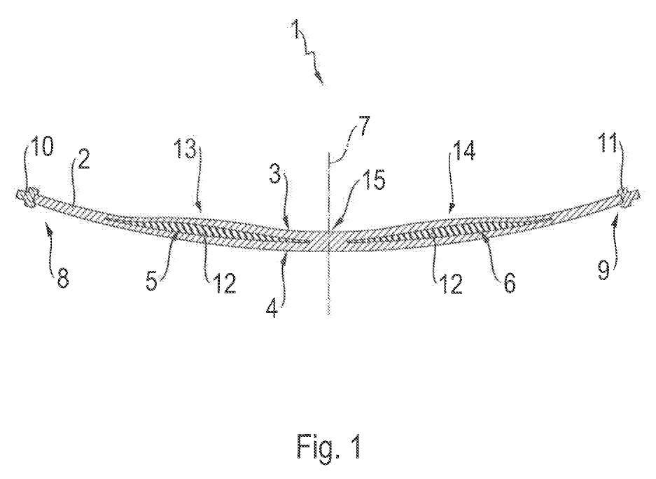

FIG. 1 shows sectional side view of an inventive first leaf spring device 1. The leaf spring device 1 is designed, in this embodiment, as one-leaf and has therefore one single spring leaf 2. The spring leaf 2 is realized as a fiber plastic compound, in this embodiment as a glass fiber plastic compound. In the present unloaded condition, the leaf spring 2 is curved or rather bent. The spring leaf 2 has a tension side 3 and a pressure side 4, positioned opposite to the tension side 3. In an installed condition of the spring leaf 2 or the leaf spring device in a vehicle or chassis not shown here, the tension side 3 is presented at the same time, as the topside and the pressure side 4 at the same time is the bottom side of the spring leaf 2.

The leaf spring device 1 or the spring leaf 2, respectively, has in this embodiment a first inner space 5 and a second inner space 6. The two inner spaces 5, 6 are positioned separate from each other or distanced from each other, respectively. Hereby, the two inner spaces 5, 6 are designed as mirror-symmetrical to a median plane 7. Also, the spring leaf 2 is mirror-symmetrical designed to the median plane 7. The median plane 7 is vertically positioned in an installed condition. In addition, the median plane 7 extends perpendicular to the longitudinal stretching of the leaf spring device 1. In an embodiment of the spring leaf 2 as a longitudinal leaf spring, the median plane 7 extends, in the installed condition, additionally perpendicular to a vehicle longitudinal axis.

The spring leaf 2 has at two ends 8, 9 of the spring leaf 2, opposite of each other, in each case and here presented schematically a fastening device 10 or 11, respectively. The spring leaf device 1 can be connected by means of the fastening devices 10, 11 to a vehicle frame and/or chassis, not presented here in detail.

In the inner spaces 5, 6, in each case, an elastic material, here actually an elastomer material 12 is positioned or inserted, respectively. In this embodiment, the inner spaces 5, 6 are completely filled with the elastic material 12. The spring leaf 2 has a first spring leaf section 13 and a second spring leaf section 14. The first spring leaf section 13 is positioned in the first inner space 5, and the second spring leaf section 14 is in the second inner space 6. The two spring leaf sections 13, 14 are positioned on the tension side 3 of the spring leaf 2. Also, the two spring leaf sections 13, 14 are positioned as mirror-symmetrical to the median plane 7.

The spring leaf sections 13, 14 are here presented in an unloaded condition of the leaf spring device 1 and bent convex to the outside. As a result, at the same time, the inner spaces 5, 6 are created. Due to the convex, curved to the outside, shape of the two spring leaf sections 13, 14, a wave shape form is created for the tension side 3. The spring leaf sections 13, 14 each create a wave crest. Between the spring leaf section 13, 14, exists a median plane 15 of the spring leaf 2. This median plane 15 creates at the same time a wave trough between the two wave crests, created by the spring leaf sections 13, 14. Starting with the spring leaf section 13 or 14, respectively, and in the direction of each nearest end 8 or 9, respectively, some kind of additional wave trough is created in the area of the tension side 3.

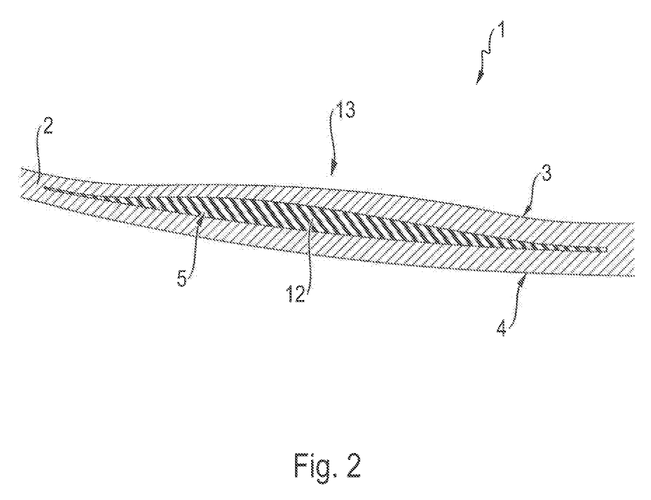

FIG. 2 shows a section of the sectional side view of the inventive first leaf spring device 1 in accordance with FIG. 1. One can see the first spring leaf section 13 and the first inner space 5. Based on the here presented, no-load condition and with an increasing spring load, the tension side 3 will be stretched. At the same time, the pressure side 4 is loaded for bending. With an increasing spring load, the elastic material 12 of in the inner space 5 or 6, respectively, is increasingly compressed. Due to the stretch load of the first spring leaf section 13 or analogous also the second spring leaf section 14, the spring leaf section 13, 14 moves in the direction of the pressure side 4 of the spring leaf 2. Hereby, a deformation or compactness, respectively, of the elastic material 12 is created.

The compression of the elastic material 12 happens at a predetermined spring load. Starting at the predetermined spring load, no further the compression of the elastic material 12 is possible. In the case of an increasing spring load, a mainly load to a bending takes place instead of an additional stretching of the tension side 3. Hereby, the stiffness of the entire leaf spring device 1 or the spring leaf 2, respectively, is strengthened. Due to the interaction of the pressure side 4, the tension side 3, the spring leaf sections 13, 14. And the elastic material 12, a progressive suspension can be realized. Hereby, the stiffness of the leaf spring device 1 or spring leaf 2 increases with an increasing spring load.

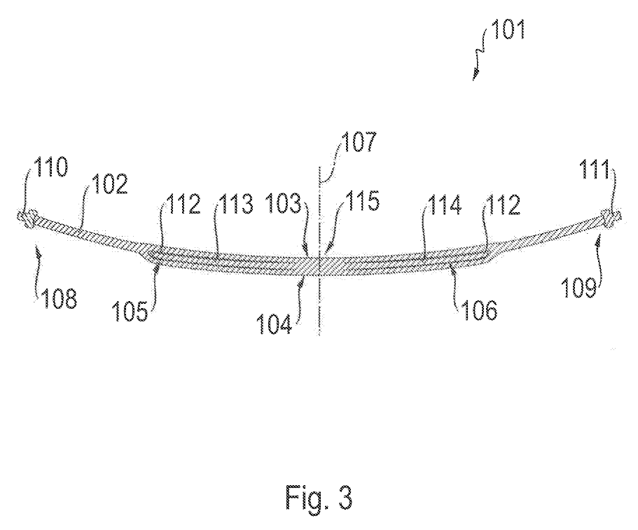

FIG. 3 shows a sectional view of the inventive additional leaf spring device 101. The leaf spring device 101 is, in this embodiment, designed as one-leaf and therefore has one single spring leaf 102. The spring leaf 102 is realized, in this embodiment, as a glass fiber plastic compound. It is here presented in the no-load condition of the spring leaf 102 as bent or rather arched. The spring leaf 102 has a tension side 103 and, positioned opposite of the tension side 103, the pressure side 104. In the here not further presented installed condition of the spring leaf 102 or rather the leaf spring device 101 in a vehicle or chassis, the tension side 103 represents also a top side and the pressure side 104 is the bottom side of the spring leaf 102.

The leaf spring device 101 or rather the spring leaf 102 has in this embodiment a first inner space 105 and a second inner space 106. The two inner spaces 105, 106 are positioned separate from each other rather at a distanced from each other. Herein, the two inner spaces 105, 106 are an integral part of the spring leaf 102. The two inner spaces 105, 106 are designed as mirror-symmetrical to a median plane 107. The spring leaf 102 is also designed as mirror-symmetrical to the median plane 107. The median plane 107 is vertically aligned in the installed condition of the spring leaf device 101. In addition, the median plane 107 extends perpendicular to the longitudinal stretching of the leaf spring device 101. In a design of the spring leaf 102 as a longitudinal leaf spring, the median plane 107 extends in the installed condition as perpendicular to a vehicle longitudinal axis.

The spring leaf 102 has at two mutually remote ends 108, 109 of the spring leaf 102 each have a fastening device 110 and 111 shown here only schematically. By means of the fastening devices 110, 111, the leaf spring device 101 can be connected with a vehicle frame and/or chassis not but further shown.

In each of the inner spaces 105, 106, an elastic material, here primarily an elastomer material 112, is positioned or rather inserted. The spring leaf 102 has a first spring leaf section 113 and a second spring leaf section 114. The first spring leaf section 113 is assigned to a first inner space 105 and the second spring leaf section 114 to the inner space 106. In this embodiment, the spring leaf sections 113, 114 are designed in a sword shape. Starting from a median plane 115 of the spring leaf 102, the spring leaf sections 113, 114 extend in the direction towards the ends 108 or 109, respectively. The inner space is 105, 106 are in this embodiment example filled with the elastic material 12 between an inner side or rather an inner perimeter of the inner spaces 105, 106 and an outer perimeter of the sword-shape spring leaf section 113, 114. The two spring leaf sections 113, 114 are designed mirror-symmetrical in reference to the median plane 7.

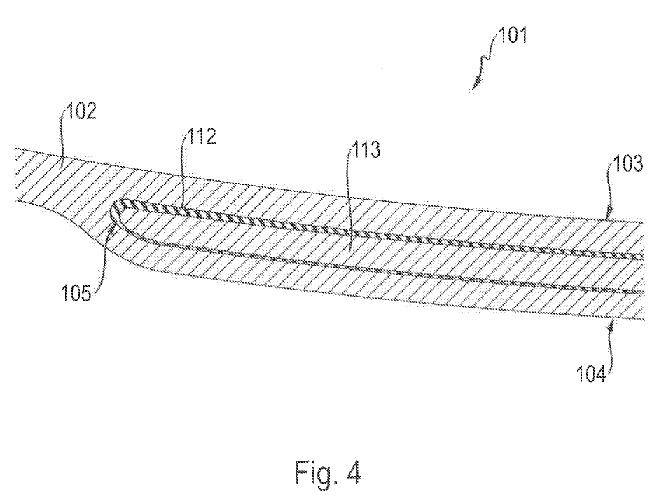

FIG. 4 shows a section of the sectional side view of the inventive leaf spring device 101 according to FIG. 3. One can see the first spring leaf section 113 and the first inner space 105. Beginning here, from the illustrated no-load condition, the elastic material 112 in the inner space 105 or the analogous inner space 106, will be increasingly deformed with an increased spring load between the outer side, facing the tension side 103, of the spring leaf section 113 or rather 114 and the inner side of the inner space 105 or 106, respectively, facing away from the tension side 103.

The deformation and/or constraints of the elastic material 112 takes place up to a predetermined spring load. Beginning with the predetermined spring load, no more compression of the elastic material 112 is possible. During an additional increase of the spring load, an additional load is taking place at the spring load section 113 or 114, respectively, for a bending. Herein, the stiffness of the entire leaf spring device 101 or rather the spring leaf 102 is strengthened. Herein a progressive suspension can be realized. Herein, the stiffness of the leaf spring device 101 or rather the spring leaf 102 continuously increases with an increasing spring load.

### REFERENCE CHARACTERS

1 Leaf Spring Device
2 Spring Leaf
3 Tension side
4 Pressure side
5 First inner space
6 Second inner space
7 Median plane
8 End
9 End
10 Fastening device
11 Fastening device
12 Elastic material
13 First spring leaf section
14 Second spring leaf section
15 Median plane
101 Spring leaf device
102 Spring leaf
103 Tension side
104 Pressure side
105 First inner space
106 Second inner space
107 Median plane
108 End
109 End
110 Fastening device
111 Fastening device
112 Elastic material
113 First spring leaf section
114 Second spring leaf section
115 Median plane

1-16. (canceled)

17. A leaf spring device for a vehicle, the leaf spring device comprising:
a spring leaf (2, 102) made from a fiber-reinforced plastic,
further comprising at least one inner space (5, 6, 105, 106), and
the inner space (5, 6, 105, 106) being at least partially or completely filled or not filled with an elastic material (12, 112).

18. The leaf spring device according to claim 17, wherein the elastic material (12, 112) is positioned between an inner side of the inner space (5, 6, 105, 106) and a spring leaf section (13, 14, 113, 114) of the spring leaf (2, 102), and the elastic material (12, 112) is located on the inner side of the inner space (5, 6, 105, 106) and on an inner side or an outer perimeter of the spring leaf section (13, 14, 113, 114).

19. The leaf spring device according to claim 17, wherein due to at least one of the inner space and an interaction of the elastic material (12, 112) and a spring leaf section (13, 14, 113, 114) of the spring leaf (2, 102), which is assigned to the inner space (5, 6, 105, 106), a stiffness of the leaf spring device (1, 101) results in at least one of an increasing suspension and a progressive suspension through an increasing spring load and an increased bending of the spring leaf (2, 102).

20. The leaf spring device according to claim 18, wherein the spring leaf (2, 102), the spring leaf section (13, 14, 113, 114), and the elastic material (12, 112) are designed to realize a stiffness of the leaf spring device (1, 101) for at least one of increasing suspension and a progressive suspension such that, starting at a no-load condition of the leaf spring device (1, 101), the elastic material (12, 112) is increasingly deformed with an increasing spring load, as the spring leaf section (13, 14, 113, 114) bends due to increasingly load.

21. The leaf spring device according to claim 17, wherein either the inner space (5, 6, 105, 106) in the spring leaf (2, 102) is designed as a cavity, or the inner space (5, 6, 105, 105) is a through hole that extends from a first side of the spring leaf (2, 102) to a second side of the spring leaf (2, 102) which is opposite to the first side, and the inner space (5, 6, 105, 106) extends, when the leaf spring device (1, 101) is installed in the vehicle, either transverse or perpendicular to a vehicle vertical axis.

22. The leaf spring device according to claim 17, wherein the leaf spring (2, 102) is mirror-symmetrical to a median plane (7, 107) which extends perpendicular to at least one of a longitudinal direction and a longitudinal axis of the leaf spring device (1, 101), and the leaf spring device (1, 101) is connectable by two fastening devices (10, 1, 110, 111), arranged at opposite ends of the leaf spring device (1, 101) to at least one of a vehicle support, a vehicle frame, and a vehicle chassis.

23. The leaf spring device according to claim 17, wherein the spring leaf (2, 102) has the inner space (5, 6, 105, 106), at least one of the leaf spring device (1, 101) and the spring leaf (2, 102) has a first inner space (5, 105) with the elastic material (12, 112) and a second inner space (6, 106) with the elastic material (12, 112), and the first inner space (5, 105) and the second inner space (6, 106) are designed mirror-symmetrical to at least one of each other and a median plane (7, 107) of the spring leaf (2, 102).

24. The leaf spring device according to claim 17, wherein a leaf spring section (13, 14) of the spring leaf (2) is stretched substantially longitudinally until a predetermined spring load, and the spring leaf section (13, 14), starting at the predetermined spring load, is resilient to bending in addition to an already achieved stress level.

25. The leaf spring device according to claim 17, wherein a leaf spring section (13, 14) of the spring leaf (2) has a convex shape under a no-load condition of the leaf spring device (1), the leaf spring section, in the no-load and installed condition of the leaf spring device (1) in the vehicle, convexly curves outwards in a direction of the vehicle vertical axis, and the leaf spring section (13, 14) is designed as section of a tension side (3) of the spring leaf (2).

26. The leaf spring device according to claim 17, wherein a tension side (3) of the spring leaf (2), during a no-load condition of the leaf spring device (1), has a wavelike form, a leaf spring section (13, 14) of the spring leaf (2) is formed as a wave crest, and at least one of the spring leaf section (13, 14) and the wave crest are positioned in an area of the inner space (5, 6).

27. The leaf spring device according to claim 17, wherein a spring leaf section (113, 114) of the spring leaf (102) extends as a sword shape into the inner space (105, 106), the elastic material (12) contact one side an inner parameter of the inner space (105, 106) and contacts another side an outer perimeter of the spring leaf section (113, 114).

28. The leaf spring device according to claim 27, wherein the sword shaped spring leaf section (113, 114) extends, starting at a median section (115) of the spring leaf (102), in at least one of a longitudinal direction of the spring leaf (102) and a direction of one end (108, 109) of the spring leaf (102), a sword shaped first spring leaf section (113), starting from a median range (115), extends in a direction of a first end (108) of the spring leaf (102), and a second spring leaf section (114), starting at the median range (115) extends in a direction of a second end (109) of the spring leaf (102) which is opposite to the first end (108).

29. The leaf spring device according to claim 17, wherein the leaf spring device (1, 101) is formed as either one-leaf or multi-leaf, the leaf spring device is formed as two-leaf, wherein a first spring leaf and a second spring leaf are firmly bonded with each other to form the at least one inner space (5, 6, 105, 106) between the first spring leaf and the second spring leaf.

30. The leaf spring device according to claim 17, wherein the leaf spring device (1, 101) is formed as two-leaf, and a first spring leaf and a second spring leaf are firmly bonded with each other to form the at least one inner space (5, 6, 105, 106) between the first spring leaf and the second spring leaf.

31. The leaf spring device according to claim 17, wherein the spring leaf (2, 102) is manufactured from at least one of a fiber-plastic compound and a glass fiber-plastic compound, and the spring leaf (2, 102) is designed as a longitudinal leaf spring.

32. A chassis with a leaf spring device (1, 101) according to claim 17, wherein the leaf spring device (1, 101) is assembled in one of a vehicle or a motor vehicle.

33. A method for the manufacturing of the leaf spring device (1, 101) for a vehicle, the method comprising:
manufacturing a spring leaf (2, 102) from a fiber-reinforced plastic,
forming the leaf spring with at least one inner space (5, 6, 105, 106), and
one of at least partially or completely filling or not filling at all the inner space (5, 6, 105, 106) with an elastic material (12, 112).
